(19) United States
(12) Patent Application Publication
(10) Pub. No.: US 2011/0277627 A1
(43) Pub. Date: Nov. 17, 2011

(54) ION AND OZONE OPTIMIZING SATURATION METHOD FOR INDOOR AIR

(76) Inventor: Sun-Tae AN, Busan (KR)

(21) Appl. No.: 13/178,714

(22) Filed: Jul. 8, 2011

Related U.S. Application Data
(63) Continuation of application No. PCT/KR2010/001148, filed on Feb. 24, 2010.

(30) Foreign Application Priority Data
Mar. 10, 2009 (KR) 10-2009-0020425

(51) Int. Cl. B03C 3/68

(52) U.S. Cl. 95/3

(57) ABSTRACT

The present invention relates to an ion and ozone optimizing saturation method for indoor air. According to the method of the present invention, voltage serial pulses of one polarity type are fed to discharge ionization electrodes, and then voltage serial pulses of another polarity type are sequentially fed after a pause longer than the time for mutual recombination of anions and cations. At this time, the concentration of ions of different polarities is adjusted by changing the pulse repetition rate of a voltage pulse in a serial pulse, duration of serial pulses of the respective polarities and duration of the pause. Additionally, a voltage pulse is fed to the discharge ionization electrodes, and simultaneously or optionally, a voltage pulse having sufficient amplitude to generate a capacity type corona discharge between electrodes during the pause between serial pulses of different polarities is fed to ozonization electrodes. At this time, a concentration of ozone is adjusted by changing the duration of voltage supply to the ozonization electrodes.

### REFERENCE TO RELATED APPLICATIONS

This is a continuation of pending International Patent Application PCT/KR2010/001148 filed on Feb. 24, 2010, which designates the United States and claims priority of Korean Patent Application No. 10-2009-0020425 filed on Mar. 10, 2009, the entire contents of which are incorporated herein by reference.

### FIELD OF THE INVENTION

The present invention relates to a method of optimally saturating ions and ozone of indoor air and, more particularly, to a method of optimally saturating ions and ozone of indoor air, wherein active oxygen (oxygen ions and ozone), together with purified air, is supplied to the interior of a room where a human being lives through an injection ventilation system by a concentration which is recommended according to international hygiene standards (hereinafter unity).

### BACKGROUND OF THE INVENTION

An air ionization and ozonization method performed by an indoor ventilation, ionization, and ozonization apparatus is well known. DC voltage enough to generate corona discharge is supplied to electrodes. One of the electrodes has a rotor blade form.

The above method is disadvantageous in that the discharge of oxygen ions and ozone cannot be automatically controlled and regulated and oxygen ions having cations and anions, having a recommended level complying with hygiene standards, cannot be obtained in principle.

The reason why cations and anions cannot be obtained when the above method is used is that DC voltage having one kind of polarities is set in the electrodes of a rotor. DC voltage is indispensable for a rotor blade to rotate in one direction as electric charge flows from the corner of the blade.

The air ionization and ozonization method performed by the air ionization apparatus is well known. According to the method, voltage enough to generate corona discharge is supplied to electrodes, with the result that ions and ozone are created. The ions and ozone are discharged from the apparatus for realizing the method to the interior of a room by means of ‘the wind of ions’, generated when ions having electric charges move in an area where corona discharge is formed, and convection current generated by heated elements within the apparatus.

In this case, cations and anions having an ionization acceptable level of air, which is recommended by hygiene standards, cannot be obtained. That is, the wind of ions is formed only when ions having one kind of polarity exist.

Another disadvantage is that apparatuses using the method cannot be used along with an aerosol purification system for providing a high air purification level owing to a sudden drop in the pressure which is formed when the ion and convection current motion mechanism of air is employed.

To use active oxygen together with air not properly purified is not permitted. Accordingly, the above method and the apparatus for implementing the method cannot be applied to an injection ventilation system.

An air ionization and ozonization method implemented by another air ozonization apparatus is well known. According to this method, voltage enough to generate corona discharge is supplied to electrodes, thereby creating ions and ozone. Air is forcedly supplied to the apparatus for implementing the present method. Accordingly, the apparatus can be combined with a high quality of an air purification system.

A disadvantage of the above method is that there is no system for controlling the intensity of generated ozone. In this case, an allowed limit ozone concentration within indoor air which is regulated by hygiene standards may rise. In addition, DC voltage is supplied to the electrodes of a chamber where ionization and discharge are generated. If there is DC voltage, it is very difficult to generate ions having two kinds of polarities with an air ionization threshold level which is recommended by hygiene standards, and the ratio of concentration cannot be controlled in principle. Accordingly, the apparatus for implementing the present method is applied to very limited fields.

### SUMMARY OF THE INVENTION

Accordingly, a method of optimally saturating ions and ozone of indoor air which is proposed by the present invention is to provide a new method capable of solving all the problems in the existing methods.

In particular, an object of the present invention is to provide a method of optimally saturating ions and ozone of indoor air, in which ozone and positive and negative oxygen ions, having a concentration regulated by hygiene standards, can be uniformly distributed into indoor air whose contaminants are previously purified.

To achieve the object, in the present invention, serial pulses of voltage having one of + and − polarities are supplied to discharge ionization electrodes, and serial pulses of voltage having the other of the polarities are sequentially supplied to the discharge ionization electrodes after a pause longer than the time taken for anions and cations to be mutually recombined. A concentration of the anions and the cations is controlled by changing the pulse repetition rate of a voltage pulse within the serial pulses, the durations of the negative and positive serial pulses, and the duration of the pause. A voltage pulse having amplitude enough to generate corona discharge of a capacity type between ozonization electrodes is determined according to a mode signal generated from a microcontroller and supplied to the ozonization electrodes simultaneously with the voltage pulse, supplied to the discharge ionization electrodes, or with a pause between the serial pulses of the different polarities. A concentration of ozone is controlled by changing the duration for which the voltage is supplied to the ozonization electrodes.

In accordance with the method of optimally saturating ions and ozone of indoor air according to the present invention, active oxygen (oxygen ions and ozone), together with purified air, is supplied to the interior of a room where a human being lives through an injection ventilation system by a concentration which is recommended according to international hygiene standards. Furthermore, a concentration of cations and anions can be optimized according to a cross-section volume structure of a room.

### DESCRIPTION OF DRAWINGS

FIG. 1 is a cross-sectional construction showing an embodiment of an apparatus for implementing a method of optimally saturating ions and ozone of indoor air which is provided by the present invention.

FIG. 2 is a block diagram showing a controller system used in the present invention.

### DETAILED DESCRIPTION OF THE INVENTION

A method of saturating ions and ozone of indoor air according to the present invention for achieving the above object is described in detail below.

According to the present invention, discharge ionization electrodes and ozonization electrodes are placed within an air current in which an aerosol and other contaminants have been previously purified and which has been forcedly formed by an injection ventilation system, and voltage enough to generate corona discharge is supplied to the electrodes.

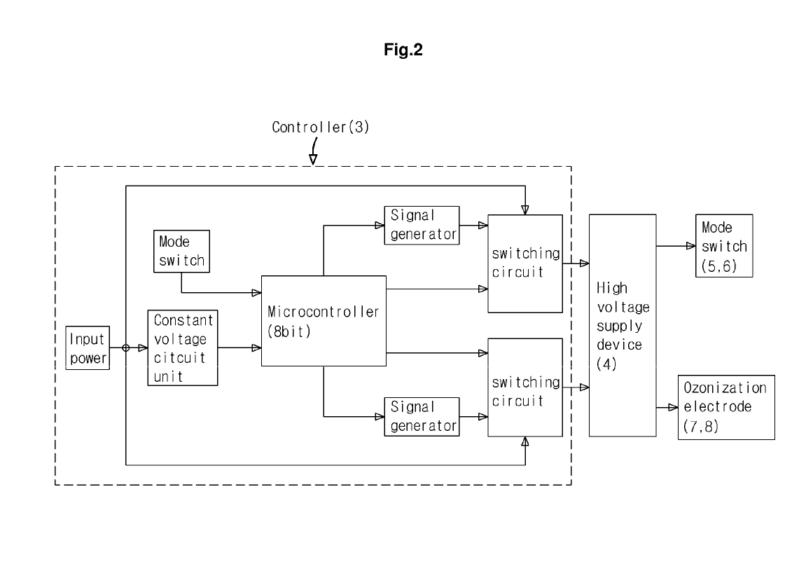

A new point of the present invention is that voltage serial pulses of one polarity are fed to discharge ionization electrodes. Next, after a pause longer than the time that anions and cations are taken to be mutually recombined, voltage serial pulses of the other polarity different from the one polarity are sequentially fed. At this time, a concentration of ions of the different polarities are controlled by a method of changing the pulse repetition rate of a voltage pulse within the serial pulses, the duration of the serial pulses of each polarity, and the duration of the pause. The control is performed in response to an inputted mode signal when the mode signal is supplied to an additional microcontroller 3 through a mode switch, as shown in FIG. 2. The generation of the serial pulses with the positive and negative polarities, the amount of voltage, the duration, and the pause time can be freely controlled. A relevant mode can be set to 16 types as shown in Table 1 below.

TABLE 1

| mode | voltage pulse | negative pulse | postive pulse |
|---|---|---|---|
| switch state | repetition | generation | generation |
| (input code) | rate (Hz) | duration (T) | duration (T) |
| 0 | 5 | 10 | 2 |
| 1 | 5 | 9 | 3 |
| 2 | 5 | 8 | 4 |
| 3 | 5 | 7 | 5 |
| 4 | 10 | 10 | 2 |
| 5 | 10 | 9 | 3 |
| 6 | 10 | 8 | 4 |
| 7 | 10 | 7 | 5 |
| 8 | 20 | 10 | 2 |
| 9 | 20 | 9 | 3 |
| A | 20 | 8 | 4 |
| B | 20 | 75 | 5 |
| C | 50 | 10 | 2 |
| D | 50 | 9 | 3 |
| E | 50 | 8 | 4 |
| F | 50 | 7 | 5 |

The voltage pulses are supplied to the discharge ionization electrodes and, at the same time or after a pause between the serial pulses with different polarities, voltage pulses of amplitude enough to generate corona discharge of a capacity type between the ozonization electrodes are supplied to the ozonization electrodes. At this time, a concentration of ozone is controlled using a method of changing duration for which voltage is supplied to the ozonization electrodes.

Furthermore, the discharge ionization electrodes and the ozonization electrodes are placed at the exit of an injection ventilation system for supplying purified air to the interior of a room. With delay after the injection ventilation system is turned on, voltage is supplied to the discharge ionization electrodes and the ozonization electrodes.

The characteristic of the present invention lies in that ozone and positive and negative oxygen ions of a concentration regulated by hygiene standards are uniformly distributed into the interior of a room in which contaminants have been previously purified indoor air.

The oxygen ions of two kinds of polarities can be uniformly distributed into the indoor space by supplying the voltage serial pulses having one polarity type to the discharge ionization electrodes and then supplying the voltage serial pulses having the other polarity type to the discharge ionization electrodes after a pause longer than the time that anions and cations are taken to be mutually recombined.

When the pause is selected as described above, ions are prevented from being mutually recombined at a place close to the exit window of the injection ventilation system. Accordingly, the extinction of ions with different polarities can be minimized, and positive (+) and negative (−) ions having an air current can be distributed into the entire indoor place.

When indoor air is filled with positive and negative oxygen ions having a concentration of a 1,000 ion/m³ level regulated y hygiene standards, a concentration of the ions with the different polarities can be controlled using a method of changing the pulse repetition rate of voltage pulses in the serial pulses, the duration of the serial pulses of each polarity, and a pause between the serial pulses of the different polarities.

The supply of ozone, having a concentration (an average ozone limit concentration a day indoors should not exceed 0.03 μg/l) regulated by hygiene standards, to indoor air is performed by controlling an ozone concentration using a method of changing duration for which voltage is supplied to the ozonization electrodes.

To fill ions and ozone into indoor air in which contaminants have been previously purified is performed with delay after the injection ventilation system is turned on when voltage is supplied to the discharge ionization electrodes and the ozonization electrodes.

Such delay above all is indispensable when contaminants exist in indoor air into which ions and ozone are filled. Such delay enables active oxygen to be supplied to a place where clean air, having contaminated air previously removed therefrom, exist.

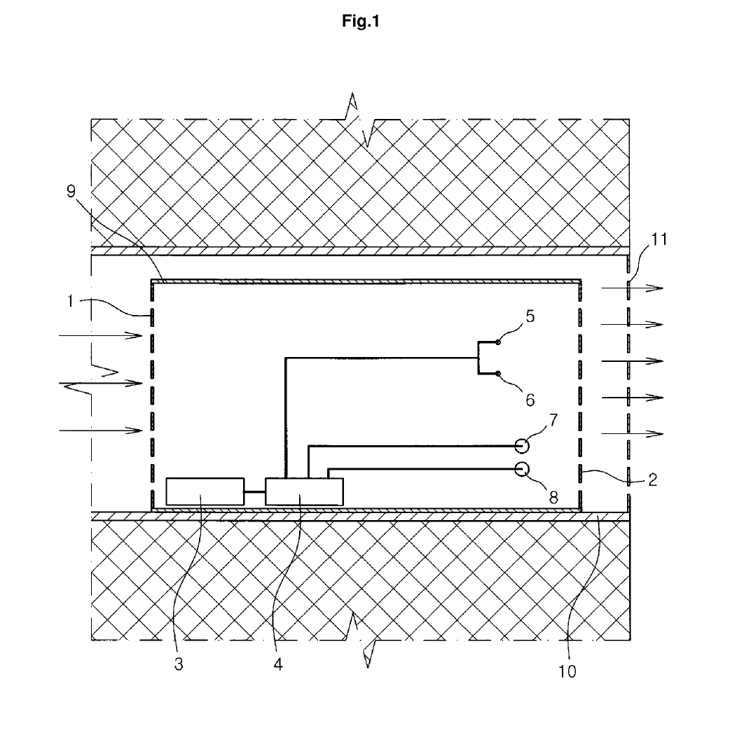

In order to help understanding of the method of the present invention, the method is shown in the figure, and FIG. 1 shows an apparatus for implementing the present method. An entrance lattice 1 is disposed on one side of a main body 9 having a tunnel form. A metal lattice (grill) 2 for discharge is disposed on the other side of the main body 9. A controller 3 and a high voltage supply device 4 are connected together within the main body 9. In the high voltage supply device 4, the discharge ionization electrodes 5 and 6 are electrically connected and the ozonization electrodes 7 and 8 are electrically connected.

The main body 9 is disposed within the ventilation channel 10 of an injection ventilation system having an air grill 11 disposed therein.

The method of optimally saturating ions and ozone of indoor air according to the present invention is described in detail according to the sequence.

When the injection ventilation system is turned on, an air current in which contaminant sources have been previously purified is supplied to the interior of a room through the air grill 11 along the ventilation channel 10. The purified air pushes the indoor contaminated air. The time that the contaminated air is taken to be replaced with the purified air is associated with the productivity of the injection ventilation system and an indoor capacity. An indoor air purification signal indicating that the apparatus is allowed to be turned on is applied from an air quality test sensor placed indoors or a timer for controlling the operation time of the injection ventilation system to the controller 3. The sensor and the timer which control the quality of indoor air are the elements of the apparatus for performing the method of the present invention, but not shown in the figures.

After the indoor air purification signal is transmitted, one of the preset modes is selected according to a mode signal supplied to the controller 3, and thus voltage is supplied from the high voltage supply device 4 to the discharge ionization electrodes 5 and 6 in the form of voltage pulses of one polarity. For example, negative voltage pulses of amplitude enough to generate corona discharge conditions within the air current are supplied. Consequently, voltage pulses of one polarity are supplied to the discharge ionization electrodes 5 and 6, and ion clusters having the relevant polarity are formed around the discharge ionization electrodes 5 and 6. The ion cluster are moved to the interior of a room through the metal lattice 2 for discharge the air grill 11 by means of the air current.

An ion concentration is controlled using a method of controlling the pulse repetition rate of pulses. As the productivity of a ventilation air current is increased, the pulse repetition rate for maintaining the ion concentration of a level designated at the entrance of the injection ventilation system is set higher. The ions of the relevant polarity corresponding to the designated amount are introduced into indoor air by controlling the duration of serial pulses of the relevant polarity.

After the duration of the negative serial pulses is finished, voltage of a negative voltage pulse form having an opposite polarity of amplitude enough to generate self-corona discharge within the air current is supplied from the high voltage supply device 4 to the discharge ionization electrodes 5 and 6 in order to saturate the indoor air with cations and anions. Likewise, the cations corresponding to a designated amount are introduced into the indoor air by controlling the duration of the positive serial pulses.

In order to prevent the ions of different polarities from being extinct at a place near the exit lattice because of mutual recombination, positive serial pulses are formed with delay and a pause not immediately after the negative serial pulses. The duration of the pause is longer than the time that the anions and cations are taken to be mutually recombined and, in general, is 1 to 10 seconds.

A method of forming the negative serial pulses again with a pause after the positive serial pulses are formed is used.

The duration of the pause is controlled within a determined range, in particular, in a reduced direction, and an ion concentration ratio of different polarities in the indoor air is controlled using the mutual recombination effect.

During the pause, voltage of an AC pulse form is supplied from the high voltage supply device 4 to the ozonization electrodes 7 and 8. To control the indoor ozone concentration in a level regulated by hygiene standards is performed using a method of changing the duration for which the voltage is supplied to the ozonization electrodes 7 and 8 during the pause. As the productivity of an ventilation air current is increased, the duration for which the voltage is supplied to the ozonization electrodes 7 and 8 is set high in order to maintain the indoor ozone concentration at an optimum level 0.01 to 0.015 μg/l.

In an experiment using equipment for realizing the method of the present invention, when the productivity of inflow-discharge ventilation is 100 to 300 m³/h in the interior of a room having a 50 to 120 m³ capacity, it was found that a light negative oxygen ion concentration and a light positive oxygen ion concentration were 2,000 ion/cm³ and 1,000 ion/cm³, respectively, and an ozone concentration was 0.01 μg/l.

It could be seen that the indices of air components are similar to optimum natural indices and they fully comply with hygiene standards.

As described above, in the detailed description of the present invention, although the detailed embodiment has been described so far, the embodiment may be modified in various ways without departing from the scope of the invention. Accordingly, the scope of the present invention should not be limited to the above-described embodiments, but should be defined by not only the scope of the appended claims and equivalent thereof.

The method of optimally saturating ions and ozone of indoor air according to the present invention may be widely applied to relevant industries.

What is claimed is:

1. A method of optimally saturating ions and ozone of indoor air, comprising:
supplying serial pulses of voltage of one polarity to discharge ionization electrodes and then sequentially supplying serial pulses of voltage of the other polarity to the discharge ionization electrodes after a pause longer than a time taken for anions and cations to be mutually recombined,
wherein a concentration of the anions and the cations is controlled by changing a pulse repetition rate of a voltage pulse within the serial pulses, durations of the negative and positive serial pulses, and a duration of the pause,
a voltage pulse having amplitude enough to generate corona discharge of a capacity type between ozonization electrodes is determined according to a mode signal generated from a microcontroller and supplied to the ozonization electrodes simultaneously with the voltage pulse, supplied to the discharge ionization electrodes, or with a pause between the serial pulses of the different polarities, and
a concentration of ozone is controlled by changing a duration for which the voltage is supplied to the ozonization electrodes.

2. The method according to claim 1, wherein:
the discharge ionization electrodes and the ozonization electrodes are disposed at an exit of an injection ventilation system for supplying purified air to the interior of a room, and
the voltage is supplied to the discharge ionization electrodes and the ozonization electrodes with delay after the injection ventilation system is turned on.
